(19) United States
(12) Patent Application Publication
(10) Pub. No.: US 2016/0077871 A1
(43) Pub. Date: Mar. 17, 2016

(54) PREDICTIVE MANAGEMENT OF HETEROGENEOUS PROCESSING SYSTEMS

(71) Applicant: Advanced Micro Devices, Inc., Sunnyvale, CA (US)

(72) Inventors: Fulya Kaplan, Boston, MA (US); Manish Arora, Dublin, CA (US); Indrani Paul, Round Rock, TX (US); Wayne P. Burleson, Shutesbury, MA (US)

(21) Appl. No.: 14/488,874

(22) Filed: Sep. 17, 2014

(51) Int. Cl. G06F 9/48; G06N 5/02

(52) U.S. Cl. CPC G06F 9/4881; G06N 5/02

(57) ABSTRACT

A heterogeneous processing device includes one or more relatively large processing units and one or more relatively small processing units. The heterogeneous processing device selectively activates a large processing unit or a small processing unit to run a process thread based on a predicted duration of an active state of the process thread.

### BACKGROUND

1. Field of the Disclosure

The present disclosure relates generally to processing systems and, more particularly, to heterogeneous processing systems.

2. Description of the Related Art

Heterogeneous processing devices such as systems-on-a-chip (SoCs) include a variety of components that have different sizes and processing capabilities. For example, a heterogeneous SoC may include a combination of one or more small central processing unit (CPUs) or processor cores, one or more large CPUs or processor cores, one or more graphics processing units (GPUs), or one or more accelerated processing units (APUs). Larger components may have higher processing capabilities that support larger throughputs, e.g., higher instructions per cycle (IPCs), as well as implementing larger prefetch engines, better branch prediction algorithms, deeper pipelines, more complex instruction set architectures, and the like. However, the increased capabilities come at the cost of increased power consumption, greater heat dissipation, and potentially more rapid aging caused by the higher operating temperatures resulting from the greater heat dissipation. Smaller components may have correspondingly lower processing capabilities, smaller prefetch engines, less accurate branch prediction algorithms, etc., but may consume less power and dissipate less heat than their larger counterparts.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a heterogeneous processing device in accordance with some embodiments.

FIG. 2 is a block diagram of heterogeneous power control logic that may be used to control the power of components in a heterogeneous processing device and allocate process threads to the components according to some embodiments.

FIG. 3 is a diagram of a two-level adaptive global predictor that may be used to predict durations of active states or idle states of a process thread according to some embodiments.

FIG. 4 is a diagram of a two-level adaptive local predictor that may be used to predict durations of an active state or an idle state of a process thread according to some embodiments.

FIG. 5 is a block diagram of a tournament predictor that may be used to predict durations of an active state or an idle state of a process thread according to some embodiments.

FIG. 6 is a flow diagram of a method of allocating new or newly activated process threads to processor cores in a heterogeneous processing device according to some embodiments.

FIG. 7 is a flow diagram of a method of migrating process threads from a small processor core to a large processor core in a heterogeneous processing device according to some embodiments.

FIG. 8 is a flow diagram of a method of migrating process threads from a large processor core to a small processor core in a heterogeneous processing device according to some embodiments.

FIG. 9 is a block diagram of a data center according to some embodiments.

FIG. 10 is a flow diagram illustrating a method for designing and fabricating an integrated circuit device implementing at least a portion of a component of a processing system in accordance with some embodiments.

### DETAILED DESCRIPTION

The components of a heterogeneous processing device can be independently activated to handle active process threads. For example, if an inactive process thread becomes active or a new process thread is initiated, the operating system or a system management unit in the heterogeneous processing device may provide operational power to a processor core to activate the processor core and allocate the newly active process thread to the newly activated processor core. The overhead required to activate the new processor core may be small relative to the resulting performance gains if the process thread is active for a relatively long time, e.g., on the order of one second. However, if the process thread is only active for a short time, e.g., 10 microseconds (μs), any performance gains that result from activating the new processor core to handle the process thread may be outweighed by the overhead required to activate the new processor core.

The overall performance of a heterogeneous processing device can be improved by selectively activating at least one processing unit in the heterogeneous processing device to run a process thread based on a predicted duration of an active state of the process thread. For example, an idle or power gated processing unit may be activated to run a process thread if the process thread has a predicted active state duration on the order of one second. However, if the predicted active state duration is smaller, e.g., on the order of a few microseconds, the process thread may be allocated to a processing unit that is already in the active state, e.g. because it was previously activated. In some embodiments, the size of the processing unit that is activated is selected based on the predicted duration of the active state of the process thread so that larger processing units are activated to handle the process threads that have longer durations and vice versa. The operating voltage or operating frequency of the processing unit at activation may also be determined based on the predicted duration of the active state of the process thread.

Processing units may also be activated (or de-activated by removing power supplied to the processing unit) to migrate a process thread between large and small processing units based on the predicted duration of the active state of the process thread. For example, if a process thread that is allocated to a large processing unit becomes active and the predicted duration of the active state is short, the process thread may migrate to a small processing unit so that the large processing unit can be de-activated to conserve power. For another example, if a process thread that is allocated to a small processing unit becomes active and the predicted duration of the active state is long, the process thread may migrate to a large processing unit to enhance performance.

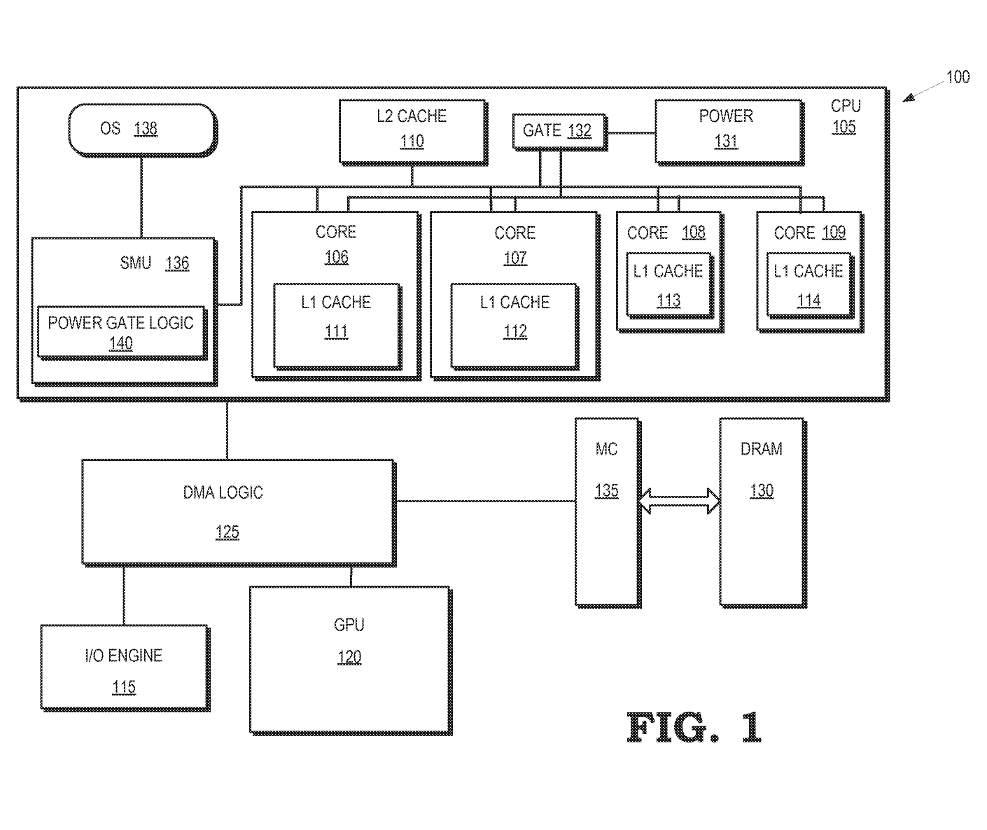

FIG. 1 is a block diagram of a heterogeneous processing device 100 in accordance with some embodiments. The heterogeneous processing device 100 includes a central processing unit (CPU) 105 for executing instructions. Some embodiments of the CPU 105 include multiple processor cores 105, 106, 107, 108, and 109 (collectively, “processor cores 106-109”) that can independently execute instructions concurrently or in parallel. The processor cores 106-109 may have different sizes. For example, the processor cores 106, 107 may be larger than the processor cores 108, 109. The “size” of a processor core may be determined by, for example, one or a combination of: the instructions per cycle (IPCs) that can be performed by the processor core, the size of the instructions (e.g., single instructions versus very long instruction words, VLIWs), the size of caches implemented in or associated with the processor cores 106-109, whether the processor core supports out-of-order instruction execution (larger) or in-order instruction execution (smaller), the depth of an instruction pipeline, the size of a prefetch engine, the size or quality of a branch predictor, whether the processor core is implemented using an x86 instruction set architecture (larger) or an ARM instruction set architecture (smaller), or other characteristics of the processor cores 106-109. The larger processor cores 106, 107 may consume more area on the die and may consume more power relative to the smaller processor cores 108, 109. Persons of ordinary skill in the art having benefit of the present disclosure should appreciate that the number or size of processor cores in the CPU 105 is a matter of design choice. Some embodiments of the CPU 105 may include more or fewer than the four processor cores 106-109 shown in FIG. 1 and the processor cores 106-109 may have a different distribution of sizes.

The CPU 105 implements caching of data and instructions and some embodiments of the CPU 105 may therefore implement a hierarchical cache system. For example, the CPU 105 may include an L2 cache 110 for caching instructions or data that may be accessed by one or more of the processor cores 106-109. Each of the processor cores 106-109 may also implement an L1 cache 111-114. The L1 caches 111, 112 may be larger than the L1 caches 113, 114 because they are associated with the larger processor cores 106, 107. For example, the number of lines in the L1 caches 111, 112 may be larger than the number of lines in the L1 caches 113, 114. Some embodiments of the L1 caches 111-114 may be subdivided into an instruction cache and a data cache.

The heterogeneous processing device 100 includes an input/output engine 115 for handling input or output operations associated with elements of the processing device such as keyboards, mice, printers, external disks, and the like.

A graphics processing unit (GPU) 120 is also included in the heterogeneous processing device 100 for creating visual images intended for output to a display, e.g., by rendering the images on a display at a frequency determined by a rendering rate. Some embodiments of the GPU 120 may include multiple cores, a video frame buffer, or cache elements that are not shown in FIG. 1 interest of clarity. In some embodiments, the GPU 120 may be larger than some or all of the processor cores 106-109. For example, the GPU 120 may be configured to process multiple instructions in parallel, which may lead to a larger GPU 120 that consumes more area and more power than some or all of the processor cores 106-109.

The heterogeneous processing device 100 shown in FIG. 1 also includes direct memory access (DMA) logic 125 for generating addresses and initiating memory read or write cycles. The CPU 105 may initiate transfers between memory elements in the heterogeneous processing device 100 such as the DRAM memory 130 and/or other entities connected to the DMA logic 125 including the CPU 105, the I/O engine 115 and the GPU 120. Some embodiments of the DMA logic 125 may also be used for memory-to-memory data transfer or transferring data between the processor cores 106-109. The CPU 105 can perform other operations concurrently with the data transfers being performed by the DMA logic 125 which may provide an interrupt to the CPU 105 to indicate that the transfer is complete. A memory controller (MC) 135 may be used to coordinate the flow of data between the DMA logic 125 and the DRAM 130.

Some embodiments of the CPU 105 may implement a system management unit (SMU) 136 that may be used to carry out policies set by an operating system (OS) 138 of the CPU 105. The OS 138 may be implemented using one or more of the processor cores 106-109. Some embodiments of the SMU 136 may be used to manage thermal and power conditions in the CPU 105 according to policies set by the OS 138 and using information that may be provided to the SMU 136 by the OS 138, such as power consumption by entities within the CPU 105 or temperatures at different locations within the CPU 105. The SMU 136 may therefore be able to control power supplied to entities such as the processor cores 106-109, as well as adjusting operating points of the processor cores 106-109, e.g., by changing an operating frequency or an operating voltage supplied to the processor cores 106-109. The SMU 136 or portions thereof may therefore be referred to as a power management unit in some embodiments.

In response to initiation of a new process thread or activation of an idle process thread, the SMU 136 selectively powers up one or more of the CPU 105, the GPU 120, or the processor cores 106-109 to run the new or newly activated process thread based on a predicted duration of an active state of the process thread. For example, the SMU 136 may activate an idle processor core 106-109 if the predicted duration of the process thread is relatively long, e.g., on the order of one second. As used herein, the term “activate” indicates that operational power is provided to an entity at a level that allows the entity to perform operations such as executing instructions. For example, an idle processor core may be activated by increasing the operational power, voltage, or frequency from a lower level to a higher level to allow the processor core to execute instructions. For another example, a power gated processor core may be activated by resupplying operational power to the processor core after the processor core was power gated to remove power and de-activate the processor core. Larger processor cores 106, 107 may be activated for longer predicted durations and smaller processor cores 108, 109 may be activated for smaller predicted durations. For another example, the SMU 136 may bypass activating an idle processor core 106-109, and instead allocate the process thread to an active processor core 106-109, if the predicted duration of the process thread is relatively short, e.g., on the order of a few microseconds. Characteristics of the process thread such as memory boundedness and instruction level parallelism may also be used to selectively activate components in the heterogeneous processing device 100.

Power management may be used to conserve power or enhance performance of the heterogeneous processing device 100. For example, dynamic voltage-frequency scaling may be used to run components in the heterogeneous processing device 100 at higher or lower operating frequencies or voltages. Components in the heterogeneous processing device 100 such as the CPU 105, the GPU 120, or the processor cores 106-109 can be operated in different performance states that may include an active state in which the component can be executing instructions and the component runs at a nominal operating frequency and operating voltage, an idle state in which the component does not execute instructions and may be run at a lower operating frequency or operating voltage, and a power-gated state in which the power supply is disconnected from the component, e.g., using a header transistor in a gate that interrupts the power supplied to the component when a power-gate signal is applied to a gate of the header transistor. In some cases, the operating frequency or operating voltage may also be increased or decreased while the component is in the active state. However, changing the operating state of the component by changing the operating frequency or operating voltage may come at a cost. For example, raising the operating voltage of the component, e.g., from 0.9 V to 0.95 V and to 1.0 V, etc., can induce noise in the component, which can degrade the performance of the component.

The SMU 136 can initiate transitions between power management states of the components of the heterogeneous processing device 100 such as the CPU 105, the GPU 120, or the processor cores 106-109 to conserve power or enhance performance. Exemplary power management states may include an active state, an idle state, a power-gated state, or other power management states in which the component may consume more or less power. Some embodiments of the SMU 136 determine whether to initiate transitions between the power management states by comparing the performance or power costs of the transition with the performance gains or power savings of the transition based on a predicted duration of an active state or an idle state of the component. Some embodiments of the SMU 136 may implement power gate logic 140 that is used to decide whether to transition between power management states. For example, the power gate logic 140 can be used to determine whether to power gate components of the heterogeneous processing device 100 such as the CPU 105, the GPU 120, or the L2 cache 110, as well as components at a finer level of granularity such as the processor cores 106-109, caches 111-114, or cores within the GPU 120. However, persons of ordinary skill in the art should appreciate that some embodiments of the heterogeneous processing device 100 may implement the power gate logic 140 in other locations. Portions of the power gate logic 140 may also be distributed to multiple locations within the heterogeneous processing device 100.

Transitions may occur from higher to lower power management states or from lower to higher power management states. For example, the SMU 136 may increase or decrease the operating voltage or operating frequency of the CPU 105, the GPU 120, or the processor cores 106-109. For another example, the heterogeneous processing device 100 include a power supply 131 that is connected to gate logic 132. The gate logic 132 can control the power supplied to the processor cores 106-109 and can gate the power provided to one or more of the processor cores 106-109, e.g., by opening one or more circuits to interrupt the flow of current to one or more of the processor cores 106-109 in response to signals or instructions provided by the SMU 136 or the power gate logic 140. The gate logic 132 can also re-apply power to transition one or more of the processor cores 106-109 out of the power-gated state to an idle or active state, e.g., by closing the appropriate circuits. However, transitions between power management states, operating voltages, operating frequencies, or power gating components of the heterogeneous processing device 100 consumes system resources. For example, power gating the CPU 105 or the processor cores 106-109 may require flushing some or all of the L2 cache 110 and the L1 caches 111-114, as well as saving information in the state registers that define the state of the CPU 105 or the processor cores 106-109.

The SMU 136 may also control migration of process thread between different components of the heterogeneous processing device 100. In some embodiments, the CPU 105, the GPU 120, or the processor cores 106-109 may be activated or powered down to migrate a process thread between one or more of these components. For example, the process thread may be migrated between the large processor cores 106, 107 and the small processor cores 108, 109 based on the predicted duration of the active state of the process thread. Once a process thread has been migrated off of one of the processor cores 106-109, this processor core can be powered down if there are no other active process threads being handled by the processor core. The SMU 136 may also activate one or more of the processor cores 106-109 so that a process thread can be migrated onto the activated processor core.

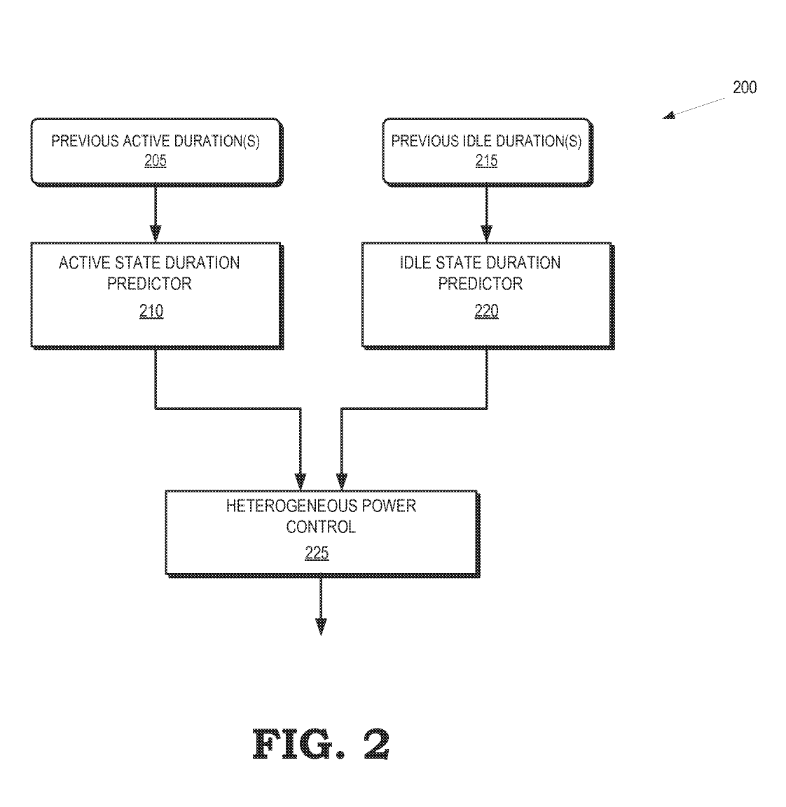

FIG. 2 is a block diagram of heterogeneous power control logic 200 that may be used to control the power of components in a heterogeneous processing device and allocate process threads to the components according to some embodiments. Some embodiments of the heterogeneous power control logic 200 may be implemented in the SMU 136 shown in FIG. 1. The heterogeneous power control logic 200 receives information 205 indicating the durations of one or more previous active states of one or more process threads executed by a heterogeneous processing device such as the heterogeneous processing device 100 shown in FIG. 1. As discussed herein, this information may be stored in a table or other data structure that may be updated in response to one or more process threads entering or leaving the active state. An active state duration predictor 210 may then use this information to predict a duration of a new or newly activated process thread. For example, a new process thread may be initiated and the processing device may activate a processor core such as one of the processor cores 106-109 shown in FIG. 1 to execute instructions for the process thread. The active state duration predictor 210 may then predict the duration of the active state of the process thread, e.g., in response to a signal indicating that the process thread is ready for execution.

Some embodiments of the heterogeneous power control logic 200 may also access information 215 indicating durations of one or more previous idle states (or other performance states) associated with the new or newly activated process thread. An idle state duration predictor 220 may then use this information to predict a duration of an idle state of the process thread. In some embodiments, the predicted idle state duration may be compared to the predicted duration of an active state of the process thread. The idle state duration predictor 220 may therefore predict the duration of an idle state in response to activation of the new or newly activated process thread.

The active state duration predictor 210 and, if implemented, the idle state duration predictor 220 may predict durations of the active and idle states, respectively, using one or more prediction techniques. The active state duration predictor 210 and the idle state duration predictor 220 may use the same prediction techniques or they may use different prediction techniques, e.g., if the different prediction techniques may be expected to provide more accurate predictions of the durations of active states and durations of idle states.

Some embodiments of the active state duration predictor 210 or the idle state duration predictor 220 may use a last value predictor to predict durations of the active or idle states. For example, to predict the duration of an active state, the active state duration predictor 210 accesses a value of a duration of an active state associated with a new or newly activated process thread when a table that stores the previous durations is updated, e.g., in response to the component that is processing the process thread entering the idle state so that the total duration of the previous active state can be measured by the last value predictor. The total duration of the active state is the time that elapses between entering the active state and transitioning to the idle state or other performance state. The updated value of the duration is used to update an active state duration history that includes a predetermined number of durations of previous active states. For example, the active state duration history, Y(t), may include information indicating the durations of the last ten active states so that the training length of the last value predictor is ten. The training length is equal to the number of previous active states used to predict the duration of the next active state.

The active state duration predictor 210 may then calculate an average of the durations of the active states in the active state history for the process thread, e.g., using equation (1) for computing the average of the last ten active states:

Y̅(̅t̅)̅=Σᵢ₌₁¹⁰*Y(t−i) (1)

Some embodiments of the active state duration predictor 210 may also generate a measure of the prediction error that indicates the proportion of the signal that is well modeled by the last value predictor model. For example, the active state duration predictor 210 may produce a measure of prediction error based on the training data set. Measures of the prediction error may include differences between the durations of the active states in the active state history and the average value of the durations of the active states in the active state history. The measure of the prediction error may be used as a confidence measure for the predicted duration of the active state.

Some embodiments of the active state duration predictor 210 or the idle state duration predictor 220 may use a linear predictor to predict durations of the performance states for the process thread. For example, the active state duration predictor 210 may access measured value(s) of the duration of the previous active state to update an active state duration history that includes a predetermined number of previous active state durations that corresponds to the training length of the linear predictor. For example, the active state duration history, Y(t), may include information indicating the durations of the last N active states so that the training length of the linear predictor is N. the active state duration predictor 210 may then compute a predetermined number of linear predictor coefficients α(i). The sequence of active state durations may include different durations and the linear predictor coefficients α(i) may be used to define a model of the progression of active state durations that can be used to predict the next active state duration for the process thread.

The active state duration predictor 210 may compute a weighted average of the durations of the idle events in the idle event history using the linear predictor coefficients α(i), e.g., using equation (2) for computing the average of the last N idle events:

Y̅(̅t̅)̅=Σᵢ₌₁^{N}α(i)*Y(t−i) (2)

Some embodiments of the linear predictor algorithm may use different training lengths or numbers of linear predictor coefficients for different process threads. Some embodiments of the active state duration predictor 210 may also generate a measure of the prediction error that indicates the proportion of the signal that is well modeled by the linear predictor model, e.g., how well the linear predictor model would have predicted the durations in the active state history. For example, the active state duration predictor 210 may produce a measure of prediction error based on the training data set. The measure of the prediction error may be used as a confidence measure for the predicted active state duration.

Some embodiments of the active state duration predictor 210 or the idle state duration predictor 220 may use a filtered linear predictor to predict durations of the active states or idle states of a process thread. For example, the active state duration predictor 210 may filter an active state duration history, Y(t), to remove outlier idle events such as events that are significantly longer or significantly shorter than the mean value of the active state durations in the history of the process thread. The active state duration predictor 210 may then compute a predetermined number of linear predictor coefficients α(i) using the filtered idle event history. The active state duration predictor 210 may also compute a weighted average of the durations of the idle events in the filtered idle event history using the linear predictor coefficients α(i), e.g., using equation (3) for computing the weighted average of the last N idle events in the filtered idle event history Y′:

Y̅(̅t̅)̅=Σᵢ₌₁^{N}α(i)*Y′(t−i) (3)

Some embodiments of the filtered linear predictor algorithm may use different filters, training lengths, and/or numbers of linear predictor coefficients for different process threads. Some embodiments of the active state duration predictor 210 may also generate a measure of the prediction error that indicates the proportion of the signal that is well modeled by the filtered linear predictor model. The measure of the prediction error may be used as a confidence measure for the predicted active state duration.

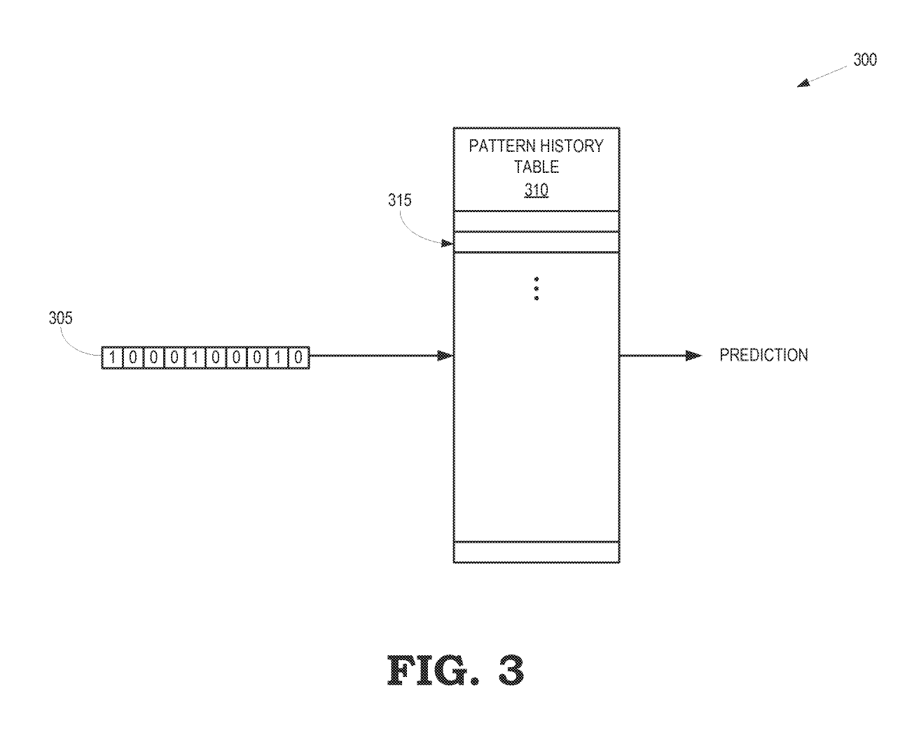

FIG. 3 is a diagram of a two-level adaptive global predictor 300 that may be used to predict durations of active states or idle states of a process thread according to some embodiments. Some embodiments of the two-level adaptive global predictor 300 may be implemented in the active state duration predictor 210 or the idle state duration predictor 220 shown in FIG. 2. The predictor 300 is referred to as “global” because the same predictor 300 is used for all process threads based on histories of the process threads executed on the processing device. The two levels used by the global predictor 300 correspond to long and short durations of a performance state for a process thread. For example, a value of “1” may be used to indicate an active state that has a duration that is longer than a threshold and a value of “0” may be used to indicate an active state that has a duration that is shorter than the threshold. The threshold may be set based on one or more performance policies, as discussed herein. The global predictor 300 receives information indicating the duration of active states and uses this information to construct a pattern history 305 for long or short duration events associated with the process thread. The pattern history 305 includes information for a predetermined number N of active states, such as the ten active states shown in FIG. 3.

A pattern history table 310 for the process thread includes 2^{N} entries 315 that correspond to each possible combination of long and short durations in the N active states. Each entry 315 in the pattern history table 310 is also associated with a saturating counter that can be incremented or decremented based on the values in the pattern history 305. An entry 315 may be incremented when the pattern associated with the entry 315 is received in the pattern history 305 and is followed by a long-duration active state. The saturating counter can be incremented until the saturating counter saturates at a maximum value (e.g., all “1s”) that indicates that the current pattern history 305 is very likely to be followed by a long duration active state. An entry 315 may be decremented when the pattern associated with the entry 315 is received in the pattern history 305 and is followed by a short-duration active state. The saturating counter can be decremented until the saturating counter saturates at a minimum value (e.g., all “0s”) that indicates that the current pattern history 305 is very likely to be followed by a short duration active state.

The two-level global predictor 300 may predict that an active state is likely to be a long-duration event when the saturating counter in an entry 315 that matches the pattern history 305 has a relatively high value of the saturating counter such as a value that is close to the maximum value. The two-level global predictor 300 may predict that an active state is likely to be a short-duration event when the saturating counter in an entry 315 that matches the pattern history 305 has a relatively low value of the saturating counter such as a value that is close to the minimum value.

Some embodiments of the two-level global predictor 300 may also provide a confidence measure that indicates a degree of confidence in the current prediction. For example, a confidence measure can be derived by counting the number of entries 315 that are close to being saturated (e.g., are close to the maximum value of all “1s” or the minimum value of all “0s”) and comparing this to the number of entries that do not represent a strong bias to long or short duration active states (e.g., values that are approximately centered between the maximum value of all “1s” and the minimum value of all “0s”). If the ratio of saturated to unsaturated entries 315 is relatively large, the confidence measure indicates a relatively high degree of confidence in the current prediction and if this ratio is relatively small, the confidence measure indicates a relatively low degree of confidence in the current prediction.

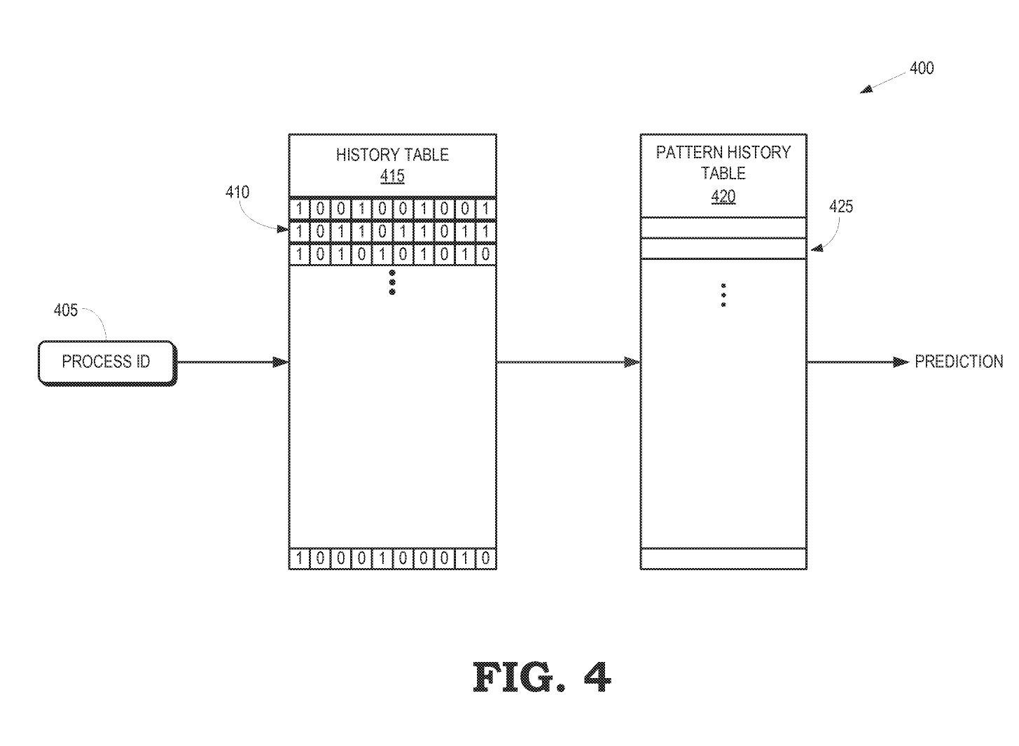

FIG. 4 is a diagram of a two-level adaptive local predictor 400 that may be used to predict durations of an active state or an idle state of a process thread according to some embodiments. The two-level adaptive local predictor 400 may be implemented in the active state duration predictor 210 or the idle state duration predictor 220 shown in FIG. 2. The predictor 400 is referred to as a “local” predictor because the predictions are made for each process thread using a history associated with the process thread, e.g., they are made on a per-process thread basis. As discussed herein, the two levels used by the local predictor 400 correspond to long and short durations of a corresponding performance state associated with a process thread. The two-level local predictor 400 receives a process identifier 405 that can be used to identify a pattern history entry 410 in a history table 415 that corresponds to the process thread. Each pattern history entry 410 is associated with a process and includes a history that indicates whether previous performance state durations associated with the corresponding process were long or short. In some embodiments, the threshold that divides long durations from short durations may be set based on performance policies, as discussed herein.

A pattern history table 420 includes 2^{N} entries 425 that correspond to each possible combination of long and short durations in the N performance states in each of the entries 410. Some embodiments of the local predictor 400 may include a separate pattern history table 420 for each process. Each entry 425 in the pattern history table 420 is also associated with a saturating counter. As discussed herein, the entries 425 may be incremented or decremented when the pattern associated with the entry 425 matches the pattern in the entry 410 associated with the process identifier 405 and is followed by a long-duration event or a short-duration performance state, respectively.

The two-level local predictor 400 may then predict that a performance state is likely to be a long-duration event when the saturating counter in an entry 425 that matches the pattern in the entry 410 associated with the process identifier 405 has a relatively high value of the saturating counter such as a value that is close to the maximum value. The two-level global predictor 400 may predict that a performance state is likely to be a short-duration performance state when the saturating counter in an entry 425 that matches the pattern in the entry 410 associated with the process identifier 405 has a relatively low value of the saturating counter such as a value that is close to the minimum value.

Some embodiments of the two-level local predictor 400 may also provide a confidence measure that indicates a degree of confidence in the current prediction. For example, a confidence measure can be derived by counting the number of entries 425 that are close to being saturated (e.g., are close to the maximum value of all “1s” or the minimum value of all “0s”) and comparing this to the number of entries 425 that do not represent a strong bias to long or short duration performance states (e.g., values that are approximately centered between the maximum value of all “1s” and the minimum value of all “0s”). If the ratio of saturated to unsaturated entries 425 is relatively large, the confidence measure indicates a relatively high degree of confidence in the current prediction and if this ratio is relatively small, the confidence measure indicates a relatively low degree of confidence in the current prediction.

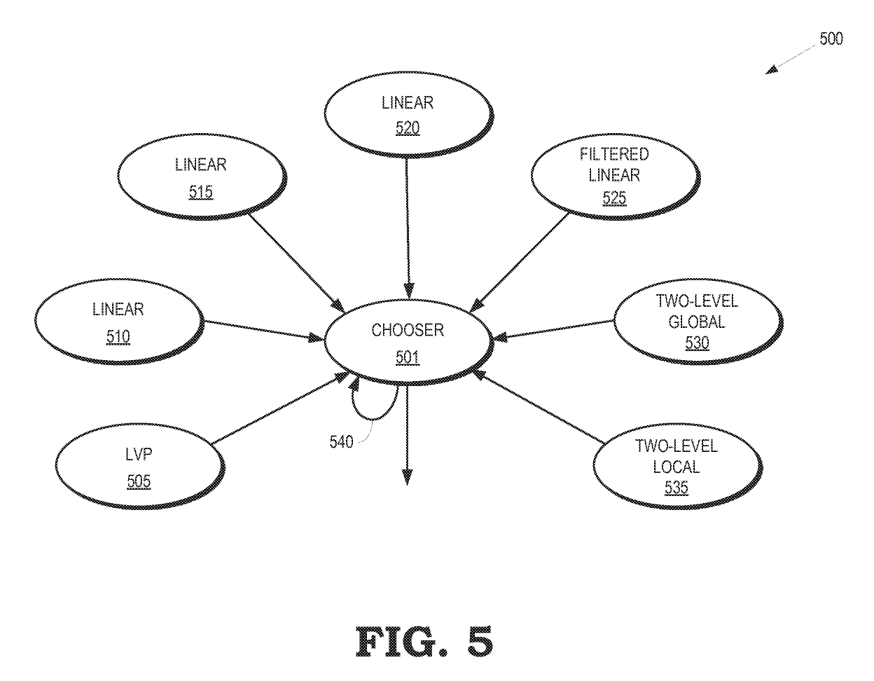

FIG. 5 is a block diagram of a tournament predictor 500 that may be used to predict durations of an active state or an idle state of a process thread according to some embodiments. The tournament predictor 500 may be implemented in the active state duration predictor 210 or the idle state duration predictor 220 shown in FIG. 2. The tournament predictor 500 includes a chooser 501 that is used to select one of a plurality of predictions of a duration of a performance state associated with the process thread provided by a plurality of different prediction algorithms, such as a last value predictor 505, a first linear prediction algorithm 510 that uses a first training length and a first set of linear coefficients, a second linear prediction algorithm 515 that uses a second training length and a second set of linear coefficients, a third linear prediction algorithm 520 that uses a third training length and a third set of linear coefficients, a filtered linear prediction algorithm 525 that uses a fourth training length and a fourth set of linear coefficients, a two-level global predictor 530, and a two-level local predictor 535. However, selection of algorithms shown in FIG. 5 is intended to be exemplary and some embodiments may include more or fewer algorithms of the same or different types.

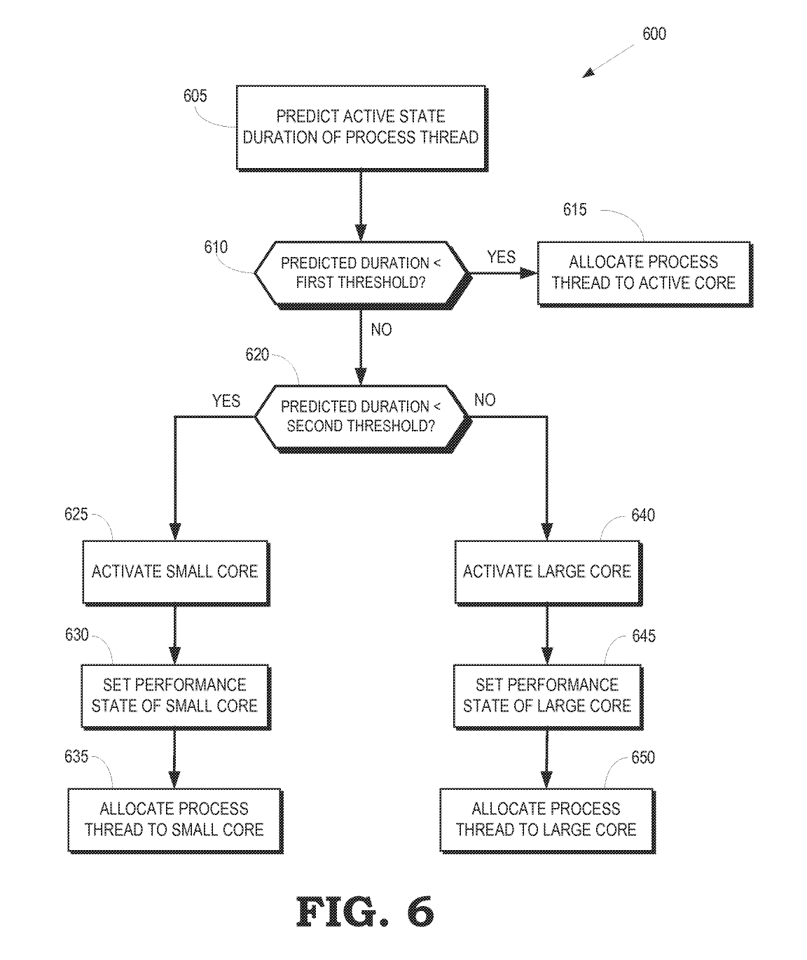

FIG. 6 is a flow diagram of a method 600 of allocating new or newly activated process threads to processor cores in a heterogeneous processing device according to some embodiments. The method 600 may be implemented in power management logic such as the SMU 136 shown in FIG. 1. Some embodiments of the method 600 may also be used to allocate new or newly activated process threads to other components such as CPUs, GPUs, or APUs in a heterogeneous processing device. The method 600 may also be used to allocate new or newly active process threads to other entities such as servers in a data center, as discussed below. A first subset of the processor cores may be considered “larger” cores and a second subset of the processor cores may be considered “smaller” cores. For example, larger cores may utilize a larger cache, have a deeper instruction pipeline, support out-of-order instruction execution, or be implemented using an x86 instruction set architecture. For another example, smaller cores may utilize a smaller cache, have a shallower instruction pipeline, allow only in-order instruction execution, or be implemented using an ARM instruction set architecture. Larger cores typically exact a higher power cost to perform tasks and smaller cores exact a lower power cost. Process threads may be distributed among the larger and smaller cores based on predicted durations of the performance states associated with the process thread such as the predicted duration of the active state of the process thread.

At block 605, the power management logic predicts durations of an active state of the new or newly activated process thread. At decision block 610, the power management logic determines whether the predicted active duration of the process thread is less than a first threshold value. If the predicted duration of the active state is less than the first threshold value, the process thread may be allocated (at block 615) to a currently active core. Thus, no inactive (e.g., idle or power gated) cores are activated at block 615. Allocating process threads that have a shorter duration to one of the active cores may conserve power because no additional cores are activated. If the predicted duration of the active state is longer than the first threshold value, the process thread may be allocated to a currently inactive core by activating the inactive core and scheduling the process thread on the activated core and so the method 600 may flow to decision block 620.

At decision block 620, the power management logic compares the predicted duration to a second threshold, which may be larger than the first threshold. The comparison may be used to decide whether to activate a small processor core or a large processor core. If the predicted duration is less than the second threshold, the power management logic may decide to activate a smaller core at block 625. Scheduling process threads that have a shorter duration to one of the smaller cores may conserve power because smaller cores require less power in the active and idle states. In some embodiments, the power management logic may also set the performance level of the smaller core at block 630. For example, an operating voltage or operating frequency of the smaller core may be set to a relatively low level (e.g., 0.9 volts) if the predicted duration is relatively short compared to a ramp-up timing overhead for changing the operating voltage or frequency and a relatively high level (e.g., 1.2 volts) if the predicted duration is relatively long compared to the ramp-up timing overhead. The process thread may then be allocated to the small processor core at block 635, which may execute the process thread.

If the comparison at decision block 620 indicates that the predicted duration is larger than the second threshold, the power management logic may decide to activate a larger core at block 640. Scheduling process threads that have a longer duration to one of the larger cores may improve the performance of the system by allowing larger capacity of the larger core(s) to work on the process thread. In some embodiments, the power management logic may also set the performance level of the smaller core at block 645. For example, an operating voltage or operating frequency of the smaller core may be set to a relatively low level (e.g., 0.9 volts) if the predicted duration is relatively short compared to a ramp-up timing overhead for changing the operating voltage or frequency and a relatively high level (e.g., 1.2 volts) if the predicted duration is relatively long compared to the ramp-up timing overhead. The process thread may then be allocated to the larger core at block 650, which may execute the process thread.

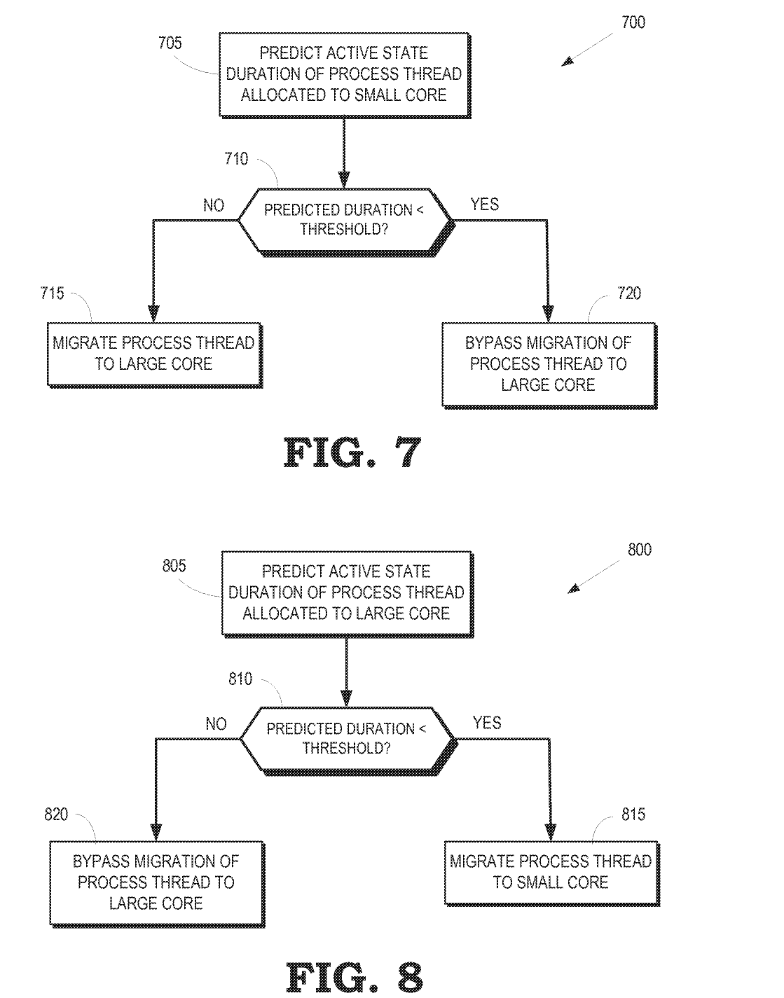

FIG. 7 is a flow diagram of a method 700 of migrating process threads from a small processor core to a large processor core in a heterogeneous processing device according to some embodiments. The method 700 may be implemented in power management logic such as the SMU 136 shown in FIG. 1. Some embodiments of the method 700 may also be used to migrate process threads between other components such as CPUs, GPUs, or APUs in a heterogeneous processing device. The method 700 may also be used to migrate process threads between other entities such as servers in a data center, as discussed below. At block 705, the power management logic predicts a duration of an active state of a process thread that has been allocated to a small processor core. At decision block 710, the power management logic compares the predicted duration to a threshold. Performance of the system while executing the process thread may be enhanced by migrating the process thread to a larger core if the predicted duration is larger than a threshold. Thus, the power management logic may migrate the process thread from the small processor core to the large processor core (at block 715) if the predicted duration is larger than the threshold. The cost of migrating the process thread to the large processor core may outweigh any performance gains if the predicted duration is smaller than the threshold. Thus, the power management logic may bypass migration of the process thread from the small processor core to the large processor core (at block 720) if the predicted duration is smaller than the threshold.

FIG. 8 is a flow diagram of a method 800 of migrating process threads from a large processor core to a small processor core in a heterogeneous processing device according to some embodiments. The method 800 may be implemented in power management logic such as the SMU 136 shown in FIG. 1. Some embodiments of the method 800 may also be used to migrate process threads between other components such as CPUs, GPUs, or APUs in a heterogeneous processing device. The method 800 may also be used to migrate process threads between other entities such as servers in a data center, as discussed below. At block 805, the power management logic predicts a duration of an active state of a process thread that has been allocated to a large processor core. At decision block 810, the power management logic compares the predicted duration to a threshold. Power may be conserved with minimal performance impact by migrating the process thread to the small processor core if the predicted duration is less than the threshold. Thus, the power management logic may migrate the process thread from the large processor core to the small processor core (at block 815) if the predicted duration is less than the threshold. The cost of migrating the process thread to the small processor core may outweigh any power savings if the predicted duration is larger than the threshold. Thus, the power management logic may bypass migration of the process thread from the large processor core to the small processor core (at block 820) if the predicted duration is smaller than the threshold.

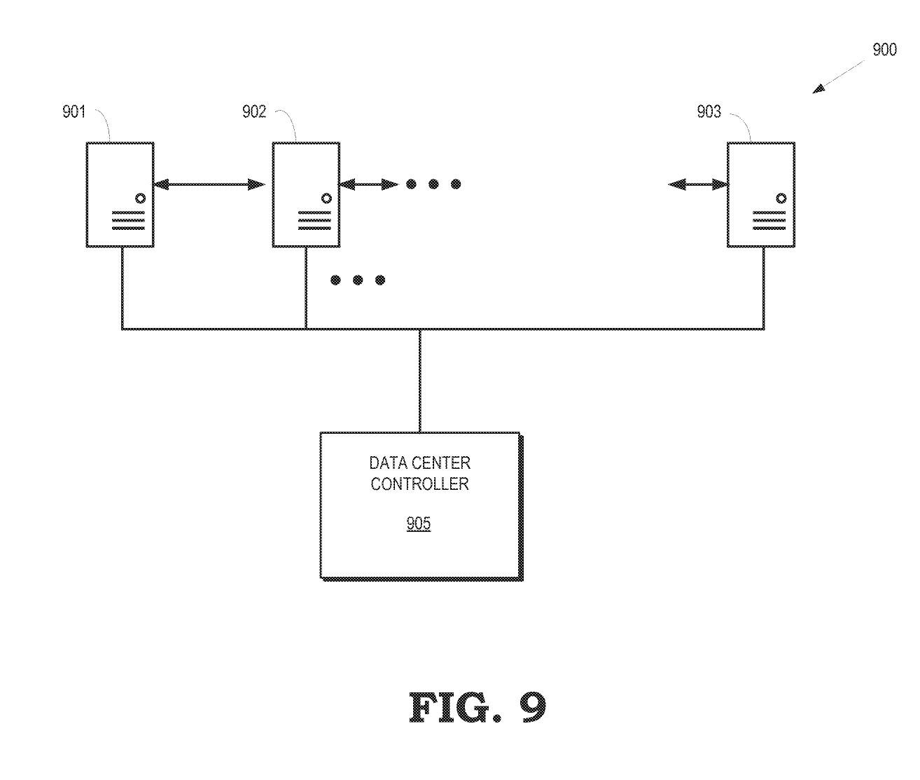

FIG. 9 is a block diagram of a data center 900 according to some embodiments. The data center 900 includes a plurality of data servers 901, 902, 903 (collectively referred to as “the data servers 901-903”). Each of the data servers 901-903 includes one or more processing devices (not shown in FIG. 9) that may include one or more CPUs, GPUs, or APUs, each of which may include one or more processing units of varying sizes. The data servers 901-903 or the data center 900 may therefore be viewed as a heterogeneous processing device. The data center 900 also includes a data center controller 905 for controlling operation of the data servers 901-903. The data center controller 905 may be implemented as a separate standalone entity or may be implemented in a distributed fashion, e.g., by implementing portions of the functionality of the data center controller 905 and one or more of the data servers 901-903. The number of data servers 901-903 in the data center 900 is, in theory, unlimited. In practice the number of data servers 901-903 may be limited by the availability of space, power, cooling, network bandwidth, or other resources.

Some embodiments of the data center controller 905 make policy decisions regarding operation of the data servers 901-903 based on predicted durations of active times for process threads or workloads that are run on the data servers 901-903. The data center controller 905 may also use idle time duration predictions or resource usage prediction of the data servers 901-903 to make the policy decisions. For example, the data center controller 905 may predict active durations, idle durations, or resource usage levels for CPUs, GPUs, memory elements, I/O devices and the like for each of the data servers 901-903. The frequency of these events may also be used to make the policy decisions. The prediction rate can vary based on the time of day or business of the data center. For example, the active and idle durations may be predicted very frequently during a busy time of day or during high bursts of activity. However, the prediction rate can be slow during low usage periods such as overnight.

Policy decisions made by the data center controller 905 may include workload consolidation and migration decisions. For example, if the predicted durations of workloads on the data servers 901-903 are of a short or medium length (e.g., as indicated by respective thresholds) and their active phases are mostly at different times, the workloads can be consolidated to a smaller number of data servers 901-903 to maximize resource utilization of the data servers 901-903. Data servers 901-903 that are not handling workloads after the consolidation may be powered down. For another example, if resource usages among multiple workloads are predicted to be orthogonal, the orthogonal workloads can be consolidated to maximize resource utilization of the data servers 901-903. For another example, if the predicted durations of the workloads on the data servers 901-903 are predicted to be relatively long and resource demand is predicted to be high, then the workload can be run on a standalone server or de-consolidated by spreading the workloads out to a larger number of data servers 901-903 to meet quality of service requirements. Predicted durations of the active period may also be used to decide whether to migrate a workload when the nature of usage of the data center 900 transitions from a low activity phase to a high activity phase.

The policy decisions may also include power management decisions. For example, if the data center controller 905 determines that the predicted durations of workloads on the data servers 901-903 are of a short or medium length, it may be better to run the data servers 901-903 at lower operating voltages or operating frequencies to save power or provide better energy efficiency. For another example, if the data center controller 905 determines that the predicted durations of workloads on the data servers 901-903 are of short or medium length, the data center controller 905 may decide to power down one or more of the data servers 901-903, take some of the data servers 901-903 off-line, or downsize to a smaller number of active processor cores, memory, or I/O devices in each of the data servers 901-903. Conversely, if the data center controller 905 determines that the predicted durations of workloads on the data servers 901-903 are relatively long and are predicted to have high resource usage, some or all of the data servers 901-903 can be activated to increase the capacity of the data center 900 and maximize system performance.

Some embodiments of the data center controller 905 may make the aforementioned policy decisions using embodiments of the techniques described herein. For example, the data center controller 905 may implement embodiments of the method 600 shown in FIG. 6, the method 700 shown in FIG. 7, or the method 800 shown in FIG. 8 to make policy decisions for the data servers 901-903 based on predicted durations of active states or idle states of process threads or workloads.

In some embodiments, the apparatus and techniques described above are implemented in a system comprising one or more integrated circuit (IC) devices (also referred to as integrated circuit packages or microchips), such as the heterogeneous processing device 100 described above with reference to FIGS. 1-9. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

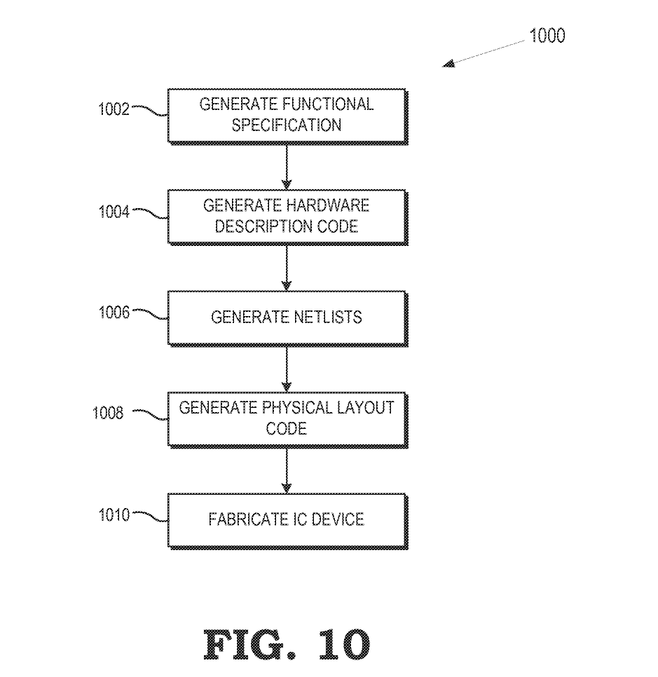

FIG. 10 is a flow diagram illustrating an example method 1000 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 1002 a functional specification for the IC device is generated. The functional specification (often referred to as a micro architecture specification (MAS)) may be represented by any of a variety of programming languages or modeling languages, including C, C++, SystemC, Simulink, or MATLAB.

At block 1004, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 1006 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 1008, one or more EDA tools use the netlists produced at block 1006 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 1010, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
selectively activating at least one processing unit in a heterogeneous processing device to run a process thread based on a first predicted duration of an active state of the process thread.

2. The method of claim 1, wherein selectively activating the at least one processing unit comprises selectively activating the at least one processing unit based on a comparison of the first predicted duration and a time required to activate the at least one processing unit.

3. The method of claim 1, wherein selectively activating the at least one processing unit comprises bypassing activating the at least one processing unit and allocating the process thread to run on a previously activated processing unit in response to the first predicted duration being less than a first threshold.

4. The method of claim 1, wherein selectively activating the at least one processing unit comprises selectively activating the at least one processing unit to at least one of an operating voltage and an operating frequency that is determined based on the first predicted duration and a ramp-up timing overhead associated with changing the at least one of the operating voltage and the operating frequency.

5. The method of claim 1, wherein:
the heterogeneous processing device comprises at least one relatively large processing unit and at least one relatively small processing unit; and
selectively activating the at least one processing unit comprises activating the at least one relatively large processing unit to run the process thread in response to the predicted duration exceeding a second threshold and activating the at least one relatively small processing unit to run the process thread in response to the predicted duration being less than or equal to the second threshold.

6. The method of claim 5, further comprising:
migrating the process thread between the at least one relatively large processing unit and the at least one relatively small processing unit based on a second predicted duration of an active state of the process thread.

7. The method of claim 6, wherein migrating the process thread comprises:
migrating the process thread from the at least one relatively large processing unit to the at least one relatively small processing unit in response to the second predicted duration being less than or equal to a third threshold; and
migrating the process thread from the at least one relatively small processing unit to the at least one relatively large processing unit in response to the second predicted duration exceeding the third threshold.

8. The method of claim 1, wherein selectively activating the at least one processing unit comprises selectively activating the at least one processing unit based on at least one of a memory bounded characteristic of the process thread and an instruction level parallelism characteristic of the process thread.

9. An apparatus comprising:
a heterogeneous processing device comprising a plurality of processing units, wherein the heterogeneous processing device is to selectively activate at least one of the processing units to run a process thread based on a first predicted duration of an active state of the process thread.

10. The apparatus of claim 9, wherein the heterogeneous processing device is to selectively activate the at least one processing unit based on a comparison of the first predicted duration and a time required to activate the processing units.

11. The apparatus of claim 9, wherein the heterogeneous processing device is to bypass activating the at least one processing unit in response to the first predicted duration being less than a first threshold, and wherein the process thread is to be allocated to run on a previously powered up processing unit.

12. The apparatus of claim 9, wherein the at least one processing unit selectively activated to at least one of an operating voltage and an operating frequency that is determined based on the first predicted duration and a ramp-up timing overhead associated with changing the at least one of the operating voltage and the operating frequency.

13. The apparatus of claim 9, wherein the at least one processing unit comprises at least one relatively large processing unit and at least one relatively small processing unit, and wherein the at least one relatively large processing unit is to selectively activate to run the process thread in response to the predicted duration exceeding a second threshold, and wherein the at least one relatively small processing unit is to selectively activate to run the process thread in response to the predicted duration being less than or equal to the second threshold.

14. The apparatus of claim 9, wherein the process thread is to migrate between the at least one relatively large processing unit and the at least one relatively small processing unit based on a second predicted duration of the active state of the process thread.

15. The apparatus of claim 14, wherein the process thread is to migrate from the at least one relatively large processing unit to the at least one relatively small processing unit in response to the second predicted duration being less than or equal to a third threshold, and wherein the process thread is to migrate from the at least one relatively small processing unit to the at least one relatively large processing unit in response to the second predicted duration exceeding the third threshold.

16. The apparatus of claim 9, wherein the at least one processing unit is selectively activated based on at least one of a memory bounded characteristic of the process thread and an instruction level parallelism characteristic of the process thread.

17. A non-transitory computer readable storage medium embodying a set of executable instructions, the set of executable instructions to manipulate at least one processor to:
selectively activate at least one processing unit in a heterogeneous processing device to run a process thread based on a first predicted duration of an active state of the process thread.

18. The non-transitory computer readable storage medium of claim 17, wherein the set of executable instructions is to manipulate at least one processor to selectively activate at least one relatively large processing unit to run the process thread in response to the predicted duration exceeding a second threshold and activate at least one relatively small processing unit to run the process thread in response to the predicted duration being less than or equal to the second threshold.

19. The non-transitory computer readable storage medium of claim 18, wherein the set of executable instructions is to manipulate at least one processor to migrate the process thread between the at least one relatively large processing unit and the at least one relatively small processing unit based on a second predicted duration of an active state of the process thread.

20. The non-transitory computer readable storage medium of claim 19, wherein the set of executable instructions is to manipulate at least one processor to migrate the process thread from the at least one relatively large processing unit to the at least one relatively small processing unit in response to the second predicted duration being less than or equal to a third threshold and to migrate the process thread from the at least one relatively small processing unit to the at least one relatively large processing unit in response to the second predicted duration exceeding the third threshold.
